(19) United States
(12) Patent Application Publication
(10) Pub. No.: US 2014/0185763 A1
(43) Pub. Date: Jul. 3, 2014

(54) INSPECTION SYSTEM AND INSPECTION METHOD

(71) Applicants: Tsinghua University, Beijing (CN); Nuctech Company Limited, Beijing (CN)

(72) Inventors: Zhiqiang CHEN, Beijing (CN); Yuanjing LI, Beijing (CN); Ziran ZHAO, Beijing (CN); Wanlong WU, Beijing (CN); Le TANG, Beijing (CN); Yinong LIU, Beijing (CN); Yingkang JIN, Beijing (CN); Guangwei DING, Beijing (CN); Shuo CAO, Beijing (CN); Zhimin ZHENG, Beijing (CN); Wenguo LIU, Beijing (CN); Wentao YU, Beijing (CN); Yi ZHOU, Beijing (CN)

(73) Assignees: TSINGHUA UNIVERSITY, Beijing (CN); NUCTECH COMPANY LIMITED, Beijing (CN)

(21) Appl. No.: 14/136,494

(22) Filed: Dec. 20, 2013

(30) Foreign Application Priority Data
Dec. 27, 2012 (CN) 201210581760.7

(51) Int. Cl. G01V 5/00

(52) U.S. Cl. CPC G01V 5/005
USPC 378/62

(57) ABSTRACT

An inspection system included a ray source to emit a ray, a detector to receive the ray, a detection region for placing an object under inspection, and a moving device to move the ray source and the detector around the detection region. Conventional scanning blind zones such as both sides of a human body, both sides of arms and both sides of legs can be completely eliminated. In addition, it is not necessary for a human body under inspection to carry out an action such as turning around to change his or her posture. Therefore, ineffective time can be minimized in the entire detection and a passing rate of persons under inspection can be improved. Furthermore, an inspected person's mental feeling of being controlled due to change of posture can be greatly improved, and his or her mental discomfort and conflicted moods can be reduced.

This application claims the benefit of Chinese Patent Application No. 201210581760.7 filed on Dec. 27, 2012, the disclosure of which is incorporated herein in its entirety by reference.

### FIELD

The present invention relates to an inspection system and an inspection method and in particular to an inspection system and an inspection method for a human body.

### BACKGROUND

In a back scattering detection and imaging apparatus, a ray pencil beam is formed by modulating and collimating a ray and it scans an object point by point while a detector receives a ray scattered from the object. Backscattering image reflecting information of the object is acquired by one-to-one correspondence between scanning positions and signals when processing data.

The generally adopted scanning mode is that a modulated and collimated ray pencil beam scans a human body in a first dimensional direction, while a plane where the ray pencil beam scans is translated along with the detector in a second dimensional direction substantially perpendicular to the first dimensional direction with respect to the human body.

Typically, there are two methods, one of which is that the ray pencil beam scans in a horizontal direction, while a plane where the ray pencil beam scans is translated in a vertical direction; and the other of which is that the ray pencil beam scans in the vertical direction, while the plane is translated in the horizontal direction.

### SUMMARY

Such a scanning mode is disadvantageous in that only an image of a side of the human body of a person under inspection close to the detector can be acquired by one scanning and detection operation, but the other side of the human body is a blind zone and can't be scanned. In order to eliminate the blind zone and acquire a complete image of the human body, after one scanning is finished, the person under inspection must turn by 180 degrees for a second scanning. In other words, two scanning detections are needed. The action of the turning will increase ineffective detection time so that a passing rate of persons under inspection decreases as a whole. For example, a typical time for scanning a single side of a human body is about 10 seconds, while a time expended as an operator informs a person under inspection that he or she can turn until he or she stands for inspection again is usually about 1.5-2 seconds. In addition, there is about another 0.5-1 second for the operator to confirm that the person under inspection has stood for inspection. As a result, the ineffective detection time is 20-30% of the total detection time. If the person under inspection is slow in action or verbal communication, more ineffective detection time will be caused.

The scanning mode has another disadvantage. That is, even if two scanning detections are performed, the human body always has surfaces parallel to a plane in which a scanning beam scans, the surfaces cannot be clearly scanned from beginning to end, and there are still small amount of blind zones in scanning such as both costal parts, and right and left sides of legs of the human body, because the plane and the detector move rectilinearly.

Accordingly, an object of an embodiment of the present invention is to provide an inspection system and an inspection method, whereby scanning a human body can be performed quickly and completely without a blind zone.

In accordance with an aspect of the present invention, there is provided an inspection system, comprising: a ray source for emitting a ray; a detector for receiving the ray; a detection region for placing an object under inspection; and a moving device for moving the ray source and the detector around the detection region.

In accordance with an aspect of the present invention, the ray source comprises a plurality of focal spots arranged in a vertical direction or may be a multi-beam X-ray source.

In accordance with an aspect of the present invention, the moving device comprises a guide rail along which the ray source and the detector move.

In accordance with an aspect of the present invention, the guide rail is circular or elliptic in shape.

In accordance with an aspect of the present invention, the guide rail is a closed ring.

In accordance with an aspect of the present invention, the ray source is integrated with the detector.

In accordance with another aspect of the present invention, there is provided an inspection method, comprising: placing an object under inspection in a detection region; and moving a ray source and a detector around the detection region while the ray source emits a ray and the detector receives the scattered ray scattered from the object under inspection.

In accordance with an aspect of the present invention, the ray source emits a ray pencil beam for scanning, and the moving device moves the ray source and the detector around the detection region.

In some embodiments, an arc-shaped path is used for moving the ray source and the detector around the detection region to perform scanning. As a result, the conventional scanning blind zones such as both sides of a human body, both sides of arms and both sides of legs can be completely eliminated. In addition, it is not necessary for a human body under inspection to carry out an action such as turning for changing a posture. Therefore, the system and method of an embodiment of the present invention can minimize the ineffective time in the entire detection and improve a passing rate of persons under inspection. Furthermore, the system and method of an embodiment of the present invention can greatly improve an inspected person's mental feeling of being controlled due to change of posture, and reduce his or her mental discomfort and conflicted moods.

Further, the conventional mechanical movement in the flying spot scanning direction is replaced with switching of focal spots of a multi-beam X-ray source. The switching of the focal spots can be achieved only by application of a control signal with a particular timing. Therefore, a complicated mechanical structure of a motor drive is greatly simplified and the scanning speed can be easily controlled.

### BRIEF DESCRIPTION OF THE DRAWINGS

FIG. 1 is a schematic view of an inspection system according to an embodiment of the present invention.

### DETAILED DESCRIPTION OF THE EMBODIMENTS

A further description of the invention will be made as below with reference to embodiments of the present invention taken in conjunction with the accompanying drawings.

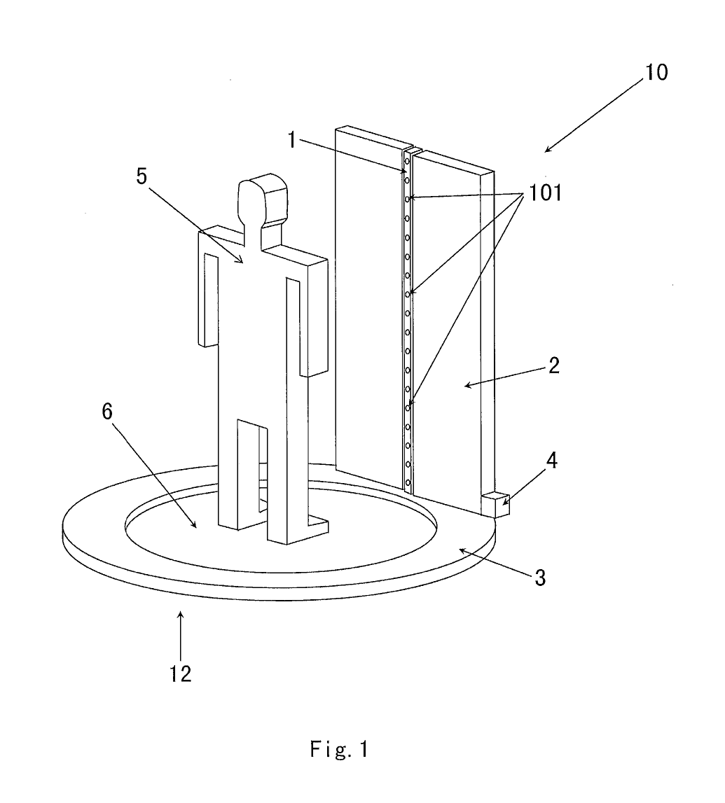

As illustrated in FIG. 1, an inspection system 10 according to an embodiment of the present invention comprises: a ray source 1 for emitting a ray; a detector 2 for receiving the ray; a detection region 6 for placing an object 5 under inspection, for example in which a person under inspection stands; a moving device 12 for moving the ray source 1 and the detector 2 around the detection region 6, and a control part 4 for controlling the system. The ray source may be integrated with the detector. The inspection system 10 may be a security inspection system for a person using ray imaging.

The moving device 12 may rotate the ray source 1 and the detector 2 around the detection region 6. For example, the ray source and the detector are rotated by the moving device integrally substantially about a vertical axis around the detection region. The moving device 12 may be any appropriate moving device so long as it can rotate the ray source 1 and the detector 2 around the detection region 6.

As illustrated in FIG. 1, the ray source 1 may be a multi-beam X-ray source such as a carbon nanotube X-ray source, and may have a plurality of ray emitting focal spots 101. For example, the ray source 1 may comprise a plurality of focal spots 101 arranged in a vertical direction. The number of the focal spots is not limited. The number of the focal spots illustrated in FIG. 1 is illustrative, and does not mean that the actual number of the focal spots is limited to it. Each target can emit a ray independently, and can be controlled to emit a ray separately in a particular sequence by an external control signal. In an embodiment, the X-ray source 1 may be a combination of a plurality of X-ray sources, such as a common field emission X-ray tube or any other appropriate radioisotope source, for example a gamma ray source.

The detector 2 can absorb the X-ray, convert the X-ray into an electrical signal, and further convert the electrical signal into a digital signal that can be displayed by a computer. The X-ray source 1 and the detector 2 may be fixed together through a connecting rod and screws such that the relative position between the X-ray source 1 and the detector 2 is maintained unchanged when they move. In an embodiment, the detector 2 is a plastic scintillator detector or a semiconductor scintillator detector.

The moving device 12 comprises a guide rail 3 along which the ray source 1 and the detector 2 move. The guide rail 3 may be an arc-shaped guide rail. The guide rail may be circular or elliptic in shape. The arc-shaped guide rail 3 provides a moving path along which the ray source 1 and the detector 2 move in a horizontal direction. The arc-shaped guide rail may be a closed ring, or a part of the closed ring. The guide rail may also be a guide rail in the shape of other curves.

The control part 4, such as a PLC (Programmable Logic Control) circuit and a microprocessor, can control a timing in which the ray source 1 emits beams, so that the plurality of focal spots 101 of the ray source 1 can emit beams in sequence, and the control part 4 strictly ensures that only one focal spot is emitting a beam at any time, thereby performing a particular flying spot scanning. For example, the plurality of focal spots 101 of the ray source 1 can emit beams in their arrangement order to perform the flying spot scanning. Alternatively, the plurality of focal spots 101 of the ray source 1 can emit beams at intervals in their arrangement direction to perform the flying spot scanning. Furthermore, the plurality of focal spots 101 of the ray source 1 can emit beams in a particular programmable sequence to perform the flying spot scanning. The control part 4 can also control both the ray source 1 and the detector 2 to move together along the arc-shaped guide rail 3.

An inspection method according to an embodiment of the present invention will be described below in detail.

The inspection method according to an embodiment of the present invention comprises: placing an object under inspection in a detection region; and moving a ray source and a detector around the detection region while the ray source emits a ray and the detector receives the scattered ray scattered from the object under inspection. The ray source may emit a ray pencil beam for scanning, and a moving device may move the ray source and the detector around the detection region.

As illustrated in FIG. 1, firstly, a person 5 under inspection enters the detection region 6 and stands still. Then the control part 4 controls the plurality of focal spots 101 of the ray source 1 to emit beams in their arrangement order, at intervals, or in a programmable sequence in the vertical direction to scan a human body of the person 5 under inspection at a uniform speed in the vertical direction. After that, the control part 4 controls the ray source 1 and the detector 2 to move integrally along the arc-shaped guide rail 3 at a preset speed. The control part 4 controls the detector 2 to acquire signals at a frequency corresponding to the timing frequency in which the ray source 1 is controlled to emit beams. When the ray source 1 and the detector 2 integrally move a whole distance of the arc-shaped guide rail 3, the entire scan of the human body is completed. Finally, the person 5 under inspection leaves the detection region 6. It is not necessary for the person 5 to carry out an action such as turning around to change his or her posture.

An arc-shaped path is adopted in an embodiment of the method of the present invention for moving the ray source and the detector around the detection region to perform scanning. As a result, the conventional scanning blind zones such as both sides of a human body, both sides of arms and both sides of legs can be completely eliminated.

In addition, with the method described above, it is not necessary for a human body under inspection to carry out an action such as turning around to change his or her posture. Therefore, the system and method of an embodiment of the present invention can minimize the ineffective time in the entire detection and improve a passing rate of persons under inspection. Furthermore, the system and method can greatly improve an inspected person's mental feeling of being controlled due to change of posture, and reduce his or her mental discomfort and conflicted moods.

Further, the conventional mechanical movement in the flying spot scanning direction is replaced with switching of focal spots of a multi-beam ray source. The switching of the focal spots can be achieved only by application of a control signal with a particular timing. Therefore, a complicated mechanical structure of a motor drive is greatly simplified and the scanning speed can be easily controlled.

What is claimed is:

1. An inspection system, comprising:
a ray source configured to emit a ray;
a detector configured to receive the ray;
a detection region for placing an object under inspection; and
a moving device configured to move the ray source and the detector around the detection region.

2. The inspection system of claim 1, wherein the ray source comprises a plurality of focal spots arranged in a vertical direction.

3. The inspection system of claim 1, wherein the moving device comprises a guide rail along which the ray source and the detector move.

4. The inspection system of claim 3, wherein the guide rail is circular or elliptic in shape.

5. The inspection system of claim 3, wherein the guide rail is a closed ring.

6. The inspection system of claim 1, wherein the ray source is integrated with the detector.

7. The inspection system of claim 1, wherein the ray source is a multi-beam X-ray source.

8. An inspection method, comprising:
placing an object under inspection in a detection region; and
moving a ray source and a detector around the detection region while the ray source emits a ray and the detector receives the scattered ray scattered from the object under inspection.

9. The inspection method of claim 8, wherein the ray source emits a ray pencil beam for scanning, and at the same time a moving device moves the ray source and the detector around the detection region.
